(19) United States
(12) Patent Application Publication
(10) Pub. No.: US 2004/0170351 A1
(43) Pub. Date: Sep. 2, 2004

(54) Electro-optic waveguide modulator method and apparatus

(76) Inventors: Tal Fishman, Haifa (IL); Ori Aphek, Givataylm (IL)

Correspondence Address: Anthony Castorina, G E Ehrlich, Suite 207, 2001 Jefferson Davis Highway, Arlington, VA, 22202, US

(21) Appl. No.: 10/479,980

(22) PCT Filed:
(86) PCT No.: PCT/IL02/00479

(30) Foreign Application Priority Data
Jun. 18, 2001 (US) 60298393
Oct. 29, 2001 (US) 60330706
Dec. 27, 2001 (US) 60342388

(51) Int. Cl. G02F 1/035

(52) U.S. Cl. 385/3; 385/39

(57) ABSTRACT

An optical modulator for modulating light with an electrical signal, the modulator comprising: an optical cavity, for enhancing an optical field of said light in a first mode, an electrical input for receiving an electrical signal, a transformer associated with said cavity and with said electrical input for transforming light within said optical field into a second mode substantially orthogonal to said first mode, in accordance with said electrical signal, and an selective output coupler associated with said optical cavity, to couple said second mode to an output, thereby to provide, at said output, light modulated in accordance with said electrical signal. Also disclosed is an internally modulated laser.

### FIELD OF THE INVENTION

The present invention relates to an improved method and apparatus for electro-optic modulation and more particularly but not exclusively to such a method and apparatus useful as an electronic-optical signal converter for use in communications and signal processing. The present invention also relates to an internally modulated laser.

### BACKGROUND OF THE INVENTION

Optical modulators are important components of high-speed optical communication and signal processing systems. To perform sufficiently well for the requirements of an optically-based communication system they must exhibit low optical insertion loss, high optical extinction ratio, small dimensions, zero (or otherwise somewhat negative) chirp parameter, low switching voltage, and most important of all, high frequency modulation bandwidth. To date, commercial modulators at 10 Gigabit/second achieve high extinction ratio (>12 dB), low chirp (<0.2 rd) and high bandwidth at the expense of a relatively high switching voltage (>5V) and large physical size (few centimeters). There is, however, a benefit to be obtained from lowering the drive voltage and/or reducing the modulator size.

Three major types of modulators are mostly used, the directly modulated laser, the Electro-Absorption (EA) and the Mach-Zehnder Interferometer (MZI). Directly modulated lasers which are the most common and cheap devices, can achieve very high frequency bandwidth (40 GHz and above) but the modulated signal is of poor quality, namely it has a large chirp parameter. An improved signal quality is obtained utilizing an external EA modulator, however, to date, for extremely high bit rates, the usage of EA modulators is limited only to short-reach optical networks (<80 Km at 10 Gb/s). The MZI, on the other hand, can produce excellent signals, with zero chirp parameter but at the expense of higher drive voltage and/or larger size of the device.

MZI's typically utilize two parallel waveguides. Light, which is symmetrically fed into the two waveguides, propagates to the output port of the device. One of the schemes, the push-pull scheme, utilizes two electrodes of opposite voltage, which surround the two waveguides. The applied voltage uses an electro-optic effect to change the refractive index at the vicinity of the electrodes. Thus, a phase difference is introduced between the light in the two waveguides. At the output of the MZI, light from the two waveguides is recombined. Without an applied voltage, light from the two waveguides constructively interferes at the output waveguide, however for a non zero applied voltage, distructive interference reduces the output power. In particular, for an applied voltage of v_{π}, which corresponds to π phase difference, only a vanishingly small amount of power is transmitted to the output port of the device. An alternative (and more precise) way of describing the MZI operation, utilizes the transverse symmetric and anti-symmetric orthogonal modes of the MZI. Here, light enters the MZI in a symmetric (or, alternatively, in the anti-symmetric) mode. The output port of the MZI selectively couples only the symmetric (anti-symmetric) mode to the output waveguide. In this approach, the voltage induced phase difference effectively transforms photons from the symmetric (anti-symmetric) mode to the anti-symmetric (symmetric) mode. Thus, for an applied voltage of v_{π}, all the input light is transformed into the anti-symmetric (symmetric) mode. Consequently, the applied voltage switches the light at the output ON and OFF. The MZI thus provides a means of modulating electrical signals onto a light beam. The main advantage of the push-pull MZI scheme over other configurations, is that if the device is kept fully symmetric, the output signal has a zero chirp parameter. Alternatively, a specific, desirable, chirp parameter can be obtain by introducing non symmetrical MZI configurations.

An alternative to the MZI but with a almost similar physical principle, utilizes the electro-optic induced polarization rotation effect. Some important disadvantages of these devices are the need for periodically alternating an RF field in order to obtain phase matching between TE and TM modes, and the need for a polarizer at the input and output ends of the device. MzI as well as Polarization modulation devices utilize both LiNbO₃ and III-V semiconductors in their construction . In addition, photo-polymers are recently immerging as a promising alternative. Utilizing traveling wave structures, a typical state of the art LiNbO₃ devices may be 15 mm long with v₉₀ =5v and 40 GHz bandwidth, whereas devices utilizing InP/InGaAsP or GaAs/AlGaAs hetero-structures are typically 4mm long with v₉₀ =4v and 40 GHz bandwidth. The performance of these devices in mainly limited by the electrical loss of the radio frequency (RF) signal at the long traveling-wave electrodes.

The following is a list of relevant publications in the field: Alferness, R. C. (1981). “Electrooptic Guided-Wave Device for General Polarization Transformation.” IEEE JQE QE-17(6): 965-969, Walker, R. G. (1991). “High-Speed II-V Semiconductor Intensity Modulators.” IEEE JQE 27(3): 654-667, Wang, S. Y., S. H. Lin, et al. (1987). “GaAs Traveling-Wave Polarization Electro-Optic Waveguide Modulator with Bandwidth in Excess of 20 GHz at 1.31 μm.” Appl. Phys. Lett. 51(2): 83-85, and Yariv, A. (1991). Optical Electronics. Orlando Fla., Saunders College Publishing. The contents of each of the above documents are hereby incorporated by reference into the present disclosure.

### SUMMARY OF THE INVENTION

According to a first aspect of the present invention there is thus provided An optical modulator for modulating light with an electrical signal, the modulator comprising:

an optical cavity, for enhancing an optical field of said light in a first mode,

an electrical input for receiving an electrical signal,

a transformer associated with said cavity and with said electrical input for transforming light within said first optical mode into a second mode substantially orthogonal to said first mode, in accordance with said electrical signal, and

a selective output coupler associated with said optical cavity, to couple said second mode to an output, thereby to provide, at said output, light modulated in accordance with said electrical signal.

Preferably, said cavity is a Fabry-Perot cavity, comprising at least two bounding mirrors.

Preferably, at least one of said bounding mirrors is a DBR mirror.

Preferably, at least one of said bounding mirrors is a cleaved mirror.

Preferably, at least one of said bounding mirrors is an etched mirror.

Preferably, at least one of said bounding mirrors is obtained by polishing.

Preferably, said bounding mirror has an HR coating.

Preferably, said cavity is a ring cavity.

Preferably, said ring cavity is a circular cavity.

Additionally or alternatively, said ring cavity is substantially polygonal.

Additionally or alternatively, said ring cavity is substantially triangular.

Additionally or alternatively, said ring cavity is substantially quadrilateral.

Additionally or alternatively, said ring cavity is substantially oblong.

Preferably, said cavity is substantially utilized with a photonic-band-gap. Preferably, said cavity is arranged to have an optical signal traveling in substantially two directions, each direction constituting one of said modes.

The modulator preferably comprises an input coupler for receiving the input light substantially into said first mode.

Preferably, said input coupler is any one of a group comprising a directional coupler; an asymmetric directional coupler; an MMI; a Bragg grating; a Y coupler; an Asymmetric Y coupler; an HR coating and a free space diffractor.

Preferably, said transformer is an interference based transformer.

Preferably, said transformer is a MZI based transformer.

Preferably, said transformer comprises an electrode set, associated with said electrical input, for effecting a phase related property of the light via an electro-optical effect to transform photons from said first optical mode to said second mode, in accordance with said electrical signal, said electrical signal being arranged for application across said electrode set.

Preferably, a first electrode of said electrode set is supplied with said electrical signal, a second electrode being held at a constant voltage.

Preferably, said electrode are set in a push-pull schema.

Preferably, said modulator is arranged to have the optical signal traveling in a substantially single direction, said direction being matched to a propagation direction of said electrical signal.

Preferably, said electrical signal is arranged to have the same velocity of propagation as the velocity of said optical signal within said transformer.

Preferably, said orthogonal modes are symmetric and anti-symmetric modes of said MZI.

Preferably, said MzI utilizes two 2×2 MMI at the input and output ports.

Preferably, said MzI utilizes a 1×2 MMI at the input and a 2×3 MMI at the output ports, respectively.

Preferably, said MZI utilizes a single 1×2 MMI at the input and output at the same time combined with a π/2 phase shifter.

Preferably, said cavity is a FP cavity.

Preferably, said selective output coupler is any one of a group comprising a directional coupler; an asymmetric directional coupler; an MMI; a Bragg grating; an Asymmetric Y coupler; a symmetric Y coupler with a single-mode central waveguide combined with a pair of angled waveguides as the output waveguides; and a free space diffraction.

Preferably, said modulator is a polarization-based modulator and said substantially orthogonal modes are substantially orthogonal polarizations.

Preferably, said optical cavity is a FP cavity.

Preferably, said optical cavity is a ring cavity.

Preferably, said selective output coupler is a polarization beam splitter.

Preferably, said selective output coupler is a waveguide based polarization beam splitter.

The modulator preferably comprises said selective output coupler is an interference based polarization splitter.

The modulator preferably comprises said substantially orthogonal polarizations are a substantially TM and substantially TE modes of a waveguide.

The modulator preferably comprises said transformer is operable to transform light within said cavity between said substantially TM mode and said substantially TE mode and wherein said polarization beam splitter is reflective to light in said substantially TM mode and transparent to light in said substantially TE mode.

The modulator preferably comprises said transformer is operable to transform light within said cavity between said substantially TM mode and said substantially TE mode and wherein said polarization beam splitter is reflective to light in said substantially TE mode and transparent to light in said substantially TM mode.

Preferably, said transformer comprises an electrode set, associated with said electrical input, for effecting a polarization related property via an electro-optical effect to transform photons from said first optical mode to said second mode, in accordance with said electrical signal, said electrical signal being arranged for application across said electrode set.

Preferably, said electro-optic effect is the electro-optically induced polarization coupling effect.

Preferably, a first electrode of said electrode set is supplied with said electrical signal, a second electrode being held at a constant voltage.

Preferably, said electrode set is arranged in a Push-Pull schema.

Preferably, said electrode set is arranged in a segmented schema in order to obtain a phase matching between said orthogonal polarizations.

The modulator preferably comprises an optical gain medium within said optical cavity.

The modulator preferably is further operable as a laser.

The modulator preferably comprises an optical gain medium within said optical cavity.

Preferably, for a null electrical signal at said electrical input, substantially no light is coupled from said optical cavity to said output.

Preferably, said electrical signal is within the radio frequency range.

Preferably, said orthogonal modes are waveguide modes.

Preferably, said waveguides are single mode waveguides.

Preferably, said waveguide is a multimode waveguide.

The modulator preferably is substantially constructed using semiconductor optical materials.

The modulator preferably is substantially constructed using a combination from the III-V semiconductor compounds.

The modulator preferably is substantially constructed using a combination from the IV-VI semiconductor compounds.

The modulator preferably is substantially constructed using a combination from the GaAs/AlGaAs family of optical materials.

The modulator preferably is substantially constructed using a combination from the InP/InGaAsP family of optical materials.

The modulator preferably is substantially constructed using Lithium-Niobate (LiNbO3).

The modulator preferably is substantially constructed using electro-optic photopolymers.

The modulator preferably is substantially constructed using reverse-biased PIN or Schottky-I/N diode in order to enhance the Electrooptic effect.

The modulator preferably is substantially constructed using Quantum-Wells in order to enhance the Electrooptic effect.

The modulator preferably is substantially constructed using resonant-tunneling diode (RTD) in order to enhance the Electrooptic effect.

The modulator preferably uses a built-in transistor in order to enhance the Electrooptic effect.

The optical modulator alternatively uses a built-in field effect transistor (FET) in order to enhance the Electrooptic effect.

According to a second aspect of the present invention there is provided an internally modulated laser comprising

an optical cavity for enhancing light in a substantially first mode and providing laser feedback,

an optical gain medium associated with said cavity,

an electrical input for receiving an electrical signal,

a transformer, associated with said electrical input and with said cavity, to couple light in said optical cavity from said first mode to a second mode, in accordance with said electrical signal, and

a selective output coupler, to direct said light in said second mode to an output.

Preferably, said cavity is a Fabry-Perot cavity, comprising at least two bounding mirrors.

Preferably, at least one of said bounding mirrors is a DBR mirror.

Preferably, at least one of said bounding mirrors is a cleaved mirror.

Preferably, at least one of said bounding mirrors is an etched mirror.

Preferably, at least one of said bounding mirrors is obtained by polishing.

Preferably, said bounding mirror has an HR coating.

Preferably, said cavity is a ring cavity.

Preferably, said ring cavity is a circular cavity.

Additionally or alternatively, said ring cavity is substantially polygonal.

Additionally or alternatively, said ring cavity is substantially triangular.

Additionally or alternatively, said ring cavity is substantially quadrilateral.

Additionally or alternatively, said ring cavity is substantially oblong.

Additionally or alternatively, the cavity is substantially utilized with a photonic-band-gap material.

Preferably, said cavity is arranged to have an optical signal traveling in substantially two directions, each direction constituting one of said modes.

Preferably, said modes are orthogonal modes.

Preferably, said transformer is an interference based transformer.

Preferably, said transformer is a MZI based transformer.

Preferably, said transformer comprises an electrode set, associated with said electrical input, for effecting a phase related property of the light via an electro-optical effect to transform photons from said first optical mode to said second mode, in accordance with said electrical signal, said electrical signal being arranged for application across said electrode set.

Preferably, a first electrode of said electrode set is supplied with said electrical signal, a second electrode being held at a constant voltage.

Preferably, said electrode are set is the push-pull schema.

Preferably, said laser is arranged to have the optical signal traveling in a substantially single direction, said direction being matched to a propagation direction of said electrical signal.

Preferably, said electrical signal is arranged to have a same velocity of propagation as a velocity of said optical signal within said transformer.

Preferably, said orthogonal modes are symmetric and anti-symmetric modes of said MZI.

Preferably, said MZI utilizes two 2×2 MMI.

Additionally or alternatively, said MZI utilizes a 1×2 MMI and a 2×3 MMI.

Additionally or alternatively, said MZI utilizes a single 1×2 MMI combined with a □/2 phase shifter.

Additionally or alternatively, said cavity is a FP cavity.

Preferably, said selective output coupler is any one of a group comprising a directional coupler; an asymmetric directional coupler; an MMI; a Bragg grating; an Asymmetric Y coupler; a symmetric Y coupler with a single-mode central waveguide combined with a pair of angled waveguides as the output waveguides; and a free space diffraction.

Preferably, said gain medium is located at an active section within said cavity.

Preferably, said cavity further comprises at least one section for tuning the laser wavelength thereby to provide a tunable internally modulated laser.

Preferably, for a null electrical signal at said electrical input, substantially no light is coupled from said optical cavity to said output.

Preferably, said electrical signal is within the radio frequency range.

Preferably, said orthogonal modes are waveguide modes.

The laser is preferably substantially constructed using semiconductor optical materials.

The laser is preferably substantially constructed using LiNbO3 as the electro-optical material.

Additionally or alternatively, the laser is substantially constructed using a reverse-biased PIN or Schottky-I/N diode in order to enhance the Electrooptic effect.

Additionally or alternatively, the laser is substantially constructed using electro-optic photopolymers.

Additionally or alternatively, the laser is substantially constructed using Quantum-Wells in order to enhance the Electrooptic effect.

Additionally or alternatively, the laser further utilizes a built-in transistor in order to enhance the Electrooptic effect.

Additionally or alternatively, the laser further utilizes a built-in field effect transistor (FET) in order to enhance the Electrooptic effect.

Preferably, said transformer is a polarization-based transformer and said orthogonal modes are substantially orthogonal polarizations of a waveguide.

Preferably, said selective output coupler is a polarization beam splitter.

Preferably, said passive section is obtained by a method of Quantum-Well intermixing.

Preferably, said passive section is obtained by a method of over growth.

Preferably, a single mode operation is obtained utilizing a DBR section.

Preferably, a single mode operation is obtained utilizing an external cavity.

Preferably, a single mode operation is obtained utilizing DFB.

According to a third aspect of the present invention there is provided a method of modulating light according to an electrical signal, comprising:

setting up an optical cavity for light in a predetermined optical state, there being a second state orthogonal to said first state,

pumping said light into an optical cavity tuned for said first state,

applying said electrical signal about said optical cavity to transform at least some of the light thereabout, via the electro-optical effect, to enter said second state, and

coupling at least some of said transformed light from said cavity, to an optical signal output, thereby to provide at said optical signal output, light modulated with said electrical signal, and wherein said second state is substantially orthogonal to said first state.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1a and 1b are schematic diagrams of a prior art Mach-Zehnder interferometer-based optical modulator with 3 dB couplers at the input and output ports.

FIG. 2 is a graph showing output amplitude against input electronic signal for the modulator of FIG. 1,

FIG. 3 is a simplified block diagram of a modulator according to a first embodiment of the present invention,

FIG. 4 is a simplified block diagram of the light modulator of FIG. 3, wherein the transformer is a Mach-Zehnder interferometer,

FIG. 5 is a simplified block diagram of a internally modulated laser according to a further embodiment of the present invention,

FIG. 6 is a simplified schematic diagram showing in greater detail a MZI based light modulator of the embodiment of FIG. 4 utilizing a 1×2 MMI device as the input 3 dB coupler and a 2×3 output combiner within a FP cavity.

FIG. 7 is a simplified schematic diagram showing in greater detail an MZI based light modulator of the embodiment of FIG. 4 utilizing a 2×2 MMI device as the input 3 dB coupler and 2×2 output combiner within a FP cavity.

FIG. 8 is a simplified schematic diagram showing in greater detail a MZI based light modulator of the embodiment of FIG. 4 utilizing a single 2×2 MMI device as the input and selective output 3 dB couplers, using a π/2 phase shifter , within a FP cavity FIG. 9 is a simplified schematic diagram of a MZI based modulation device of the embodiment of FIG. 4,

FIG. 10 is a simplified schematic diagram showing a further MZI based modulation device according to the embodiment of FIG. 4,

FIG. 11 is a simplified schematic diagram showing a yet further MZI based modulation device according to the embodiment of FIG. 4,

FIG. 12 is a simplified schematic diagram showing a further MZI based modulation device according to the embodiment of FIG. 4,

FIG. 13 is a simplified schematic diagram of an embodiment of the present invention using a ring cavity defined with mirrors,

FIG. 14 is a simplified schematic diagram of an embodiment of the present invention using a waveguide defined circular-type ring cavity,

FIG. 15 is a simplified block diagram of the light modulator of FIG. 3, wherein the transformer is a polarization transformer, and

FIG. 16 is a simplified block diagram of the light modulator of FIG. 15 shown in greater detail.

### DESCRIPTION OF THE PREFERRED EMBODIMENTS

In the following embodiments, there is provided a cavity enhanced modulator. The device uses two (or some times more) substantially orthogonal modes of the system, one of which is tuned to the cavity and has high Q for optical field enhancement and the other with low Q, for easy decoupling of the signal. Orthogonal modes of a system in that sense, are defined as modes in which power carried by one of the modes will not couple to an adjacent mode without the introduction of an external perturbation to the system. The device has similarities to the prior art devices described in the background hereinabove, in particular with respect to implementation materials, crystal orientation, waveguide definition, and electrode design. However, the described device utilizes an optical cavity to enhance the optical field in one of the modes, which may be, for example, a polarization, axial or a normal mode. Prior art describes a cavity enhanced modulator with two non-orthogonal modes and of different structure. An electrical signal uses the opto-electric effect to transform light in the cavity to the non-enhanced (low Q) mode. A selective output coupler couples the resulting transformed light to the output port but leaves light in the high Q mode in the cavity, thereby to provide a light signal modulated according to an electrical input. In such a device the normal state at the output is off, that is, in the absence of an electrical signal, ideally, a vanishingly small amount of light reaches the output A particularly preferred embodiment of the device typically has v_{π}<4v, is 200-4000 μm long and has a bandwidth which may exceed the 40 GHz limit.

According to a further embodiment of the present invention there is provided an internally modulated laser. The internally modulated laser is similar to the previous embodiments but further comprises a gain medium which is internal to the optical cavity, thus allowing for a reduction in device count as the functions of the laser and the modulator are performed in one device.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

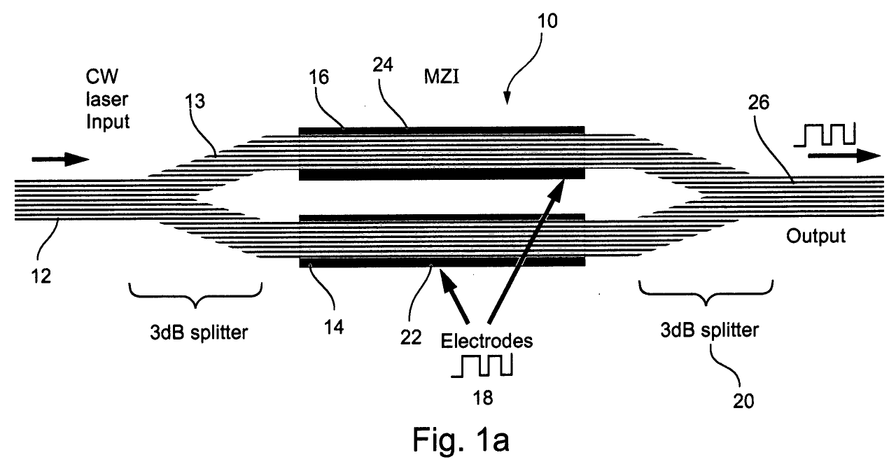

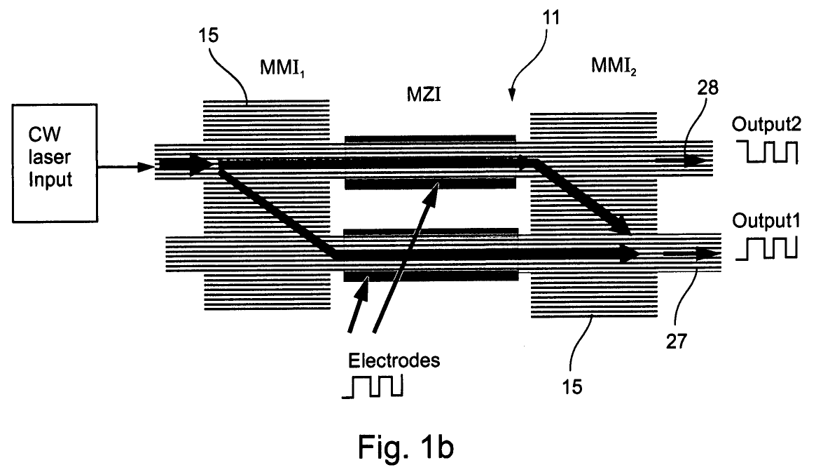

Reference is now made to FIG. 1a, which is a simplified schematic diagram of a known Mach-Zehnder interferometer (MZI) of a kind used for modulating electrical signals onto light for optical communication. The MZI is currently believed to be the fastest and highest quality way of shuttering/modulating light that is available for communication use. Light of a given intensity is input to an interferometer 10 at a single input 12, which is followed by a 3 db splitter 13. The light is carried in a waveguide 13 which is split via two equal length paths 14 and 16 where they pass an electrode region 18 and then recombined again at the optical combiner 20. An input signal is applied between a positive electrode 22 and negative electrode 24, setting up an electric field across the optical paths. The electrode region is arranged so that the fields across the two paths are respectively of opposite polarity (the push-pull configuration). Due to the electro-optic effect, the refractive index within the waveguide paths is changed in accordance with the electrical field as locally experienced. The localized changes in refractive index serve to inject a phase change into the light traveling through the respective paths and the phase change allows for constructive or destructive interference at the optical combiner 20. The light output appears at the output 26 of the combiner 20.

In use, light enters the MZI in a symmetric mode via input the 3 dB splitter 13. The optical combiner 20 selectively couples only the symmetric mode to the output 26. The electrodes introduce a voltage which operates via the electrooptic effect to induce a phase change. The voltage induced phase difference effectively transforms photons from the symmetric mode to the anti-symmetric mode. Thus, for an applied voltage of v₉₀ , all the input light is transformed into the anti-symmetric mode. Consequently, the applied voltage switches the light at the output ON and OFF. Because of the push pull nature of the electrodes there is no overall phase change due to the applied time varying field. The modulated signal, thus created, has a negligible chirp parameter. In an alternative schema, the input splitter and output combiner are utilized using a 3 dB multi-mode interference (MMI) device.

Reference is now made to FIG. 1b, which is a simplified schematic diagram of an MZI 11 utilizing a 2×2 multi-mode interference MMI device 15 replacing the Y coupler 13 as a 3 dB coupler and combiner. Such a configuration of the MZI is advantageous over the one in FIG. 1a because MMIs are simpler to implement and more robust then Y couplers. Another advantage of the device of FIG. 1b is that it has two outputs of opposite sign, either or both of which can be utilized

Such an MMI device is discussed in the following two documents, R. M. Jenkins, J. M. Heaton, D. R. Wight, J. T. Parker, J. C. H. Birbeck, G. W. Smith, K. P. Hilton, “Novel 1×N and N×N integrated optical switches using self-imaging multimode GaAs/AlGaAs waveguides”, Appl. Phys. Lett. 64 (6), 1994, and M. Bachmann, P. A. Besse, H. Melchior, “General self-imaging properties in N×N multimode interference couplers including phase relations,” Applied Optics, Vol. 33, pp. 3905-3911, July 1994. The contents of both documents are hereby incorporated by reference.

Light into device 11 enters in an anti-symmetric mode rather in a symmetric mode as in the device of FIG. 1a. This can be understood since the 2×2 MMI introduces a π/2 phase difference between its two outputs. Since two MMIs are utilized, the total phase shift, without an externally applied electric field, between the two paths of light is overall π. Upon introducing an external field to the electrodes, light is conditionally transformed into the symmetric mode of the system and reaches the second exit of the MMI (MMI₂). MMI₂ thus acts as a selective output coupler that transfers the anti-symmetrical mode to waveguide output 1, 27 and the symmetrical mode to waveguide output 2, 28.

In order to achieve an electro-optic effect, the device of FIG. 1 uses an electro-optically active waveguide, and typical materials that can be used to construct such a waveguide include: Lithium Niobate, and III-V hetero-structures such as AlGaAs/GaAs, and InGaAsP/InP and their related materials with an appropriate doping as depicted in the references. Alternatively, electro-optic photopolymers may be used.

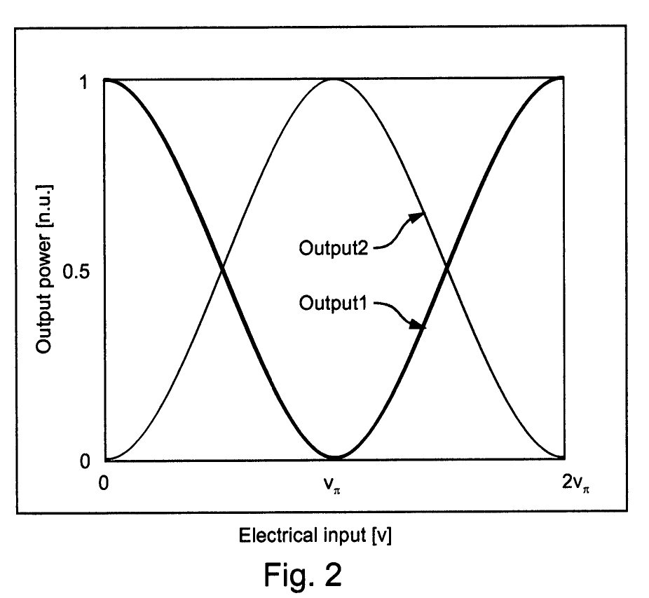

Reference is now made to FIG. 2, which is a simplified graph showing how the light output varies with the input signal for the prior art device of FIG. 1b. In FIG. 2, the input signal varies by v_{π} and the corresponding signal intensity at output1 varies between a maximum and 0. At the zero signal level, interference is maximally constructive since the two signals are in phase. At v_{π} the two signals are completely out of phase and interference is maximally destructive, giving zero light output. It is noted that the normal state of the device, i.e. the state under zero signal, is the on state, that is to say the prior art device of FIG. 1 is normally on (referring to output1, 27, at FIG. 1b). Furthermore, the switching voltage v_{π} is relatively high, around 5V, requiring relatively long electrodes, and therefore increasing the size of the overall device. The device has a high extinction ratio, that is to say the ratio between the output power in the ON state and the output power in the OFF state. The ideal device has a high output power in the ON state and zero output power in the OFF state, but physical limitations prevent the OFF state from being an accurate zero. In general, normally-ON interferometers are used because they give high levels of light in the ON state.

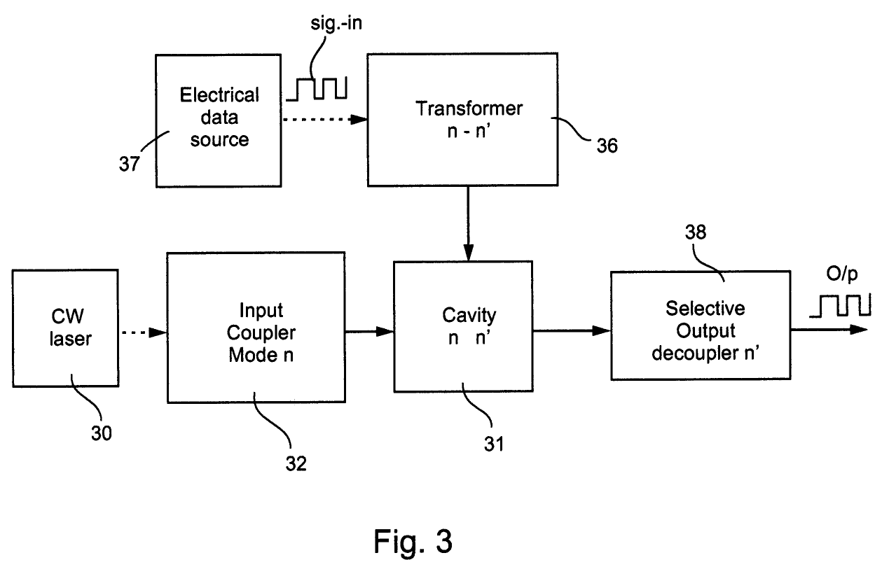

Reference is now made to FIG. 3, which is a simplified block diagram of a light modulating device according to a first preferred embodiment of the present invention. In FIG. 3, light input preferably from a CW laser source 30 reaches an optical cavity 31 via an optical input coupler 32. The cavity is defined for light in a first mode, n. Associated with the cavity 30 is a transformer 36, which receives an electrical signal sig.-in, from an electrical data source 37, for modulating onto the light. The transformer 36 transforms light associated with the cavity to a mode n′, which is orthogonal to the mode n in the cavity. A selective output decoupler 38 decouples the light in mode n′ from the cavity. The decoupled light is thus enabled to make its way to an output. The transformation is carried out in accordance with the incoming electrical signal, which originates form electrical data source 37, as mentioned above, so that zero signal gives zero transformation and maximum signal gives maximum transformation. There is thus provided a normally-off light modulator with good extinction ratio and (depending on the transformer design) a zero chirp parameter. Furthermore, the optical cavity serves as a light amplifier so that a bright output is achieved for low voltage levels, thus allowing a reduction in size of the electrodes and thus of the overall device. The cavity itself has a relatively long time constant, long that is in terms of the tens of Gb/s order of magnitude for which modulation is required. The above embodiment provides a way of modulating the light and connecting the light to the output at the very instant that the modulation takes effect. It is noted, however, that if the input signal is kept high (i.e., at the ON state) for a long period of time, the output signal of from the device will eventually decay to a lower value, thus distorting the output signal.

In the present embodiments the first mode n is a mode with high Q with respect to the cavity. The high Q mode is used in effect to gather and store photons, and then the modulation is used to decouple the stored photons from the cavity and instead couple them to an output. The result is to benefit from light storage in the cavity to produce amplified light levels at the output. The high Q photons are bounded within the cavity, in a state in which the photons are able to achieve long lifetimes. However, they are also in effect highly damped so that they are unsuitable for providing a high speed signal. The low Q mode provides a low photon lifetime but also low damping, and the embodiments benefit from both modes. That is to say the embodiments use a relatively low voltage to move what is in fact only a small proportion but nevertheless a large number of photons into low Q mode to provide a high speed output signal.

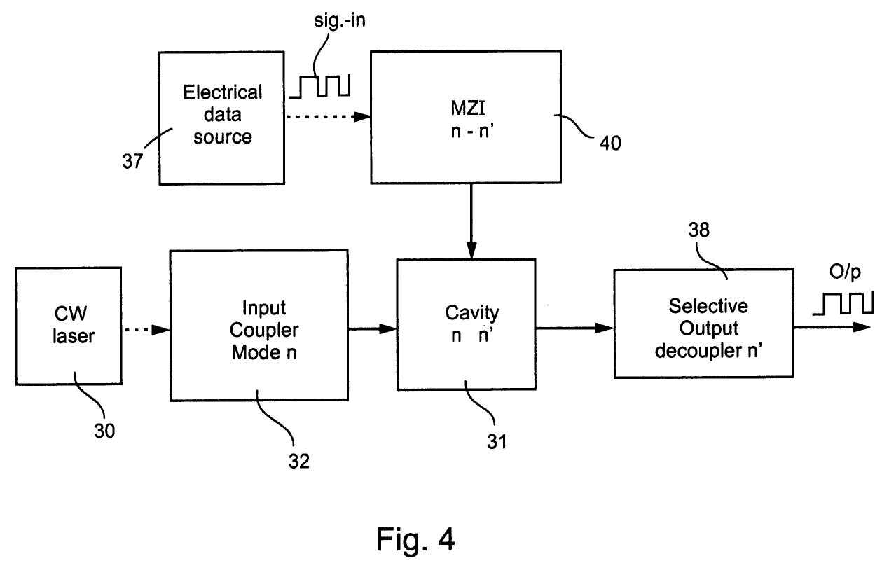

Reference is now made to FIG. 4, which is a simplified block diagram showing a variation of the device of FIG. 3 utilizing an MZI as the transformer. Parts that are the same as those in previous figures are given the same reference numerals and are not described again except as necessary for an understanding of the present embodiment. In the embodiment of FIG. 4, the transformer is provided by an MzI 40, of the kind described above. Light in mode n enters the optical cavity via coupler 32, and light in mode n is amplified in the cavity. The ON state of the interferometer transforms light to an orthogonal mode n′ which is decoupled from the cavity by the selective output coupler 34 and thus able to reach an output. The light is amplified by the cavity, typically to about ten times, and thus a relatively low input voltage may still achieve previously attained light output levels.

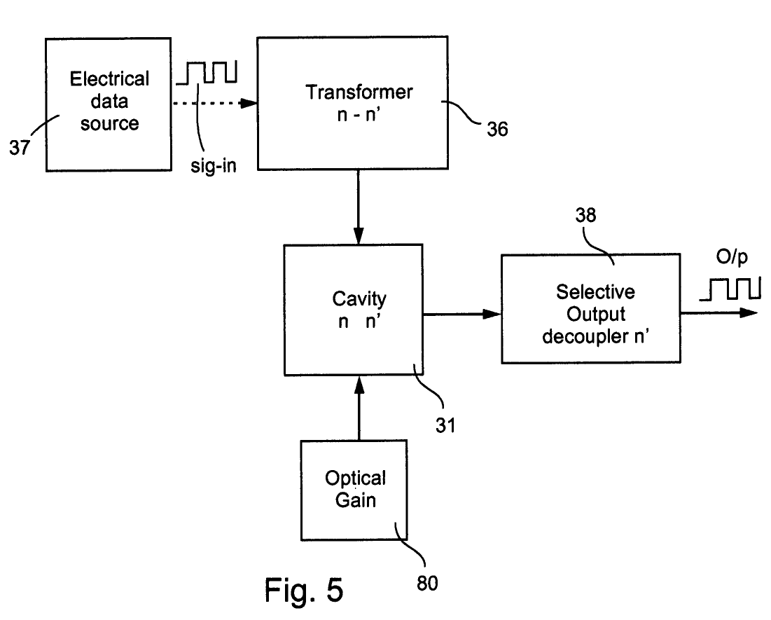

Reference is now made to FIG. 5, which is a simplified block diagram of an internally modulated laser according to a further embodiment of the present invention. Parts that are the same as those in previous figures are given the same reference numerals and are not described again except as necessary for an understanding of the present embodiment. FIG. 5 is the same as FIG. 3 except that a gain medium 80 is added, in association with cavity 31 replacing the input coupler as the source of light for mode n. The gain medium provides internal light generation, thus obviating the need for an external light source and thereby providing an internally modulated laser. The light produced is modulated in the manner described in the previous embodiments, as opposed to the traditional method of switching the gain ON and OFF. Switching ON and OFF of gain leads to photon depletion and thus introduces inertia into the switching. In addition, the change in gain introduces time dependent phase shift, which produces large chirp parameter in the output signal. In contrast, the present embodiment provides fast switching by leaving the gain untouched. The resulting device is an internally modulated laser having low chirp and high extinction ratio, which are obtained due to the fact that the laser's gain is kept almost in steady-state while the modulation is done on a fraction of the intensity in the cavity.

A method for obtaining single mode lasing, such as Bragg grating, is preferably applied. Bragg gating may be used in conjunction with wavelength selectivity of the cavity defining mirrors.

An advantage of the embodiment of FIG. 5 is to decrease device count and thereby improve reliability and ease maintenance.

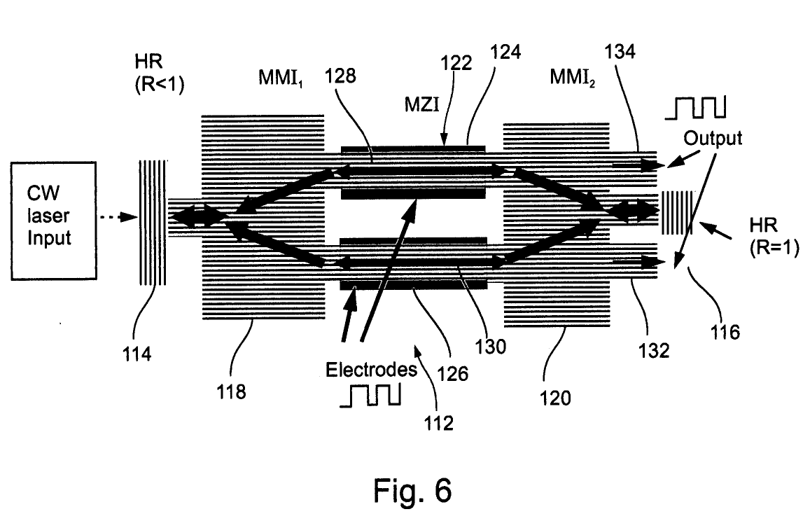

Reference is now made to FIG. 6, which is a simplified schematic diagram showing in greater detail a MZI based light modulator of the embodiment of FIG. 4 utilizing a 1×2 MMI device as the input 3 dB coupler and a 2×3 output combiner. The device comprises a cavity 112 formed between two HR mirrors an input mirror 114, and 116. In a preferred embodiment, when the device is implemented utilizing a III/V hetero-structure, the HR mirrors 114, 116 are obtained by cleaving and farther by a deposition of a multi-layer thin-film coating of the resultant cleaved facets. Light input is via the input mirror 114 which serves together with MM₁ 118 as the input coupler for the symmetric-mode of the MZI (mode n). A second MMI 120 serves as the selective out coupler for the anti-symmetric mode of MZI 122. The MZI 122, comprises electrodes 124 and 126, which surround waveguides 128 and 130 respectively. Two outputs 132 and 134 guide the decoupled photons from the cavity. The two outputs are preferably joined together further downstream to ensure a full strength signal.

The cavity 112 shown in FIG. 6 is a Fabry-Perot type cavity (FP). The cavity may be considered as comprising three regions as follows: an MZI region 122, an input multi-mode interface MMI 118 region and an output MMI 120 region. The input MMI 118 acts as a 3 dB coupler of the input light that enters the MZI 122 region in the symmetric (even) transverse-mode of the MZI. Alternatively, a Y coupler can be used, as explained above. The MZI conditionally transforms light from the symmetric (even) and the anti-symmetric (odd) transverse-modes when voltage is applied across its electrodes 122, 124. The output MMI separates the symmetric and the anti-symmetric modes so that the anti-symmetric mode decouples from the cavity to the output ports 132, 134, while the in-phase symmetric mode remains in the cavity. (Other configurations can be arranged so that the symmetric and anti-symmetric are alternately replaced). The partial reflectivity of the mirror 114, or the level of coupling-in features in the Fabry-Perot cavity, are preferably set by taking into account the losses in the cavity, so as to maximize energy coupled into the cavity.

In summary, light is injected into the cavity in the in-phase mode. If no voltage is applied on the MZI, no energy is transferred to the anti-symmetric mode; and thus the output power is zero. When voltage is applied, a fraction of the energy of the in-phase symmetric mode is transferred to the anti-symmetric mode at the MZI section. The MMI 120 region directs the energy of the antisymmetric mode to the output ports, 132, 134, leaving the remaining in-phase energy in the cavity.

In FIG. 6, it is noteworthy that both light amplification and modulation occur within the optical cavity.

Again, the device in FIG. 6, may be combined with a gain medium within the cavity, to provide an internally modulated laser. In such a case the input mirror 114 may be replaced by a fully reflective mirror.

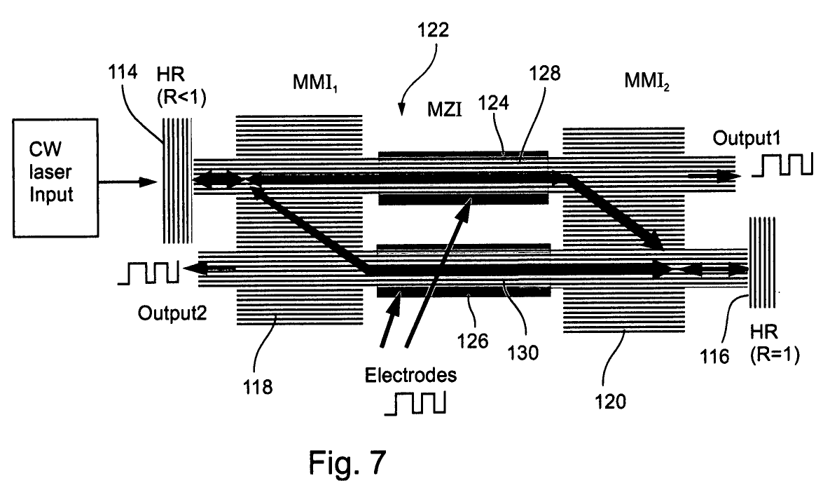

Reference is now made to FIG. 7, which is a simplified schematic diagram showing in greater detail a MZI based light modulator of the embodiment of FIG. 4 utilizing a 2×2 MMI device as the input 3 dB coupler and 2×2 output combiner. The device is very similar to the device of FIG. 6 but as in FIG. 1b, above, the mode in the cavity is an anti-symmetric mode of the system (i.e., the system of the two MMIs and the MZI). Parts that are the same as those in previous figures are given the same reference numerals and are not described again except as necessary for an understanding of the present embodiment. Light input is via the input mirror 114 which serves together with MMI₁ 118 as the input coupler for the anti-symmetric-mode of the system (mode n). A second MMI 120 serves as the selective out coupler for the symmetric mode of the system. The MZI 122, comprising electrodes 124 and 126 surrounding waveguides 128 and 130 respectively. The output 132 guides the decoupled photons from the cavity. The major advantage of this configuration over the configuration presented in FIG. 6 is its single output which simplifies the manufacturing of the device.

Again, both light amplification and modulation are carried out within the cavity, and again the device may be combined with a gain medium within the cavity to form a internally modulated laser of the kind shown in FIG. 5. In such a case the input mirror 114 may be replaced by a fully reflective mirror.

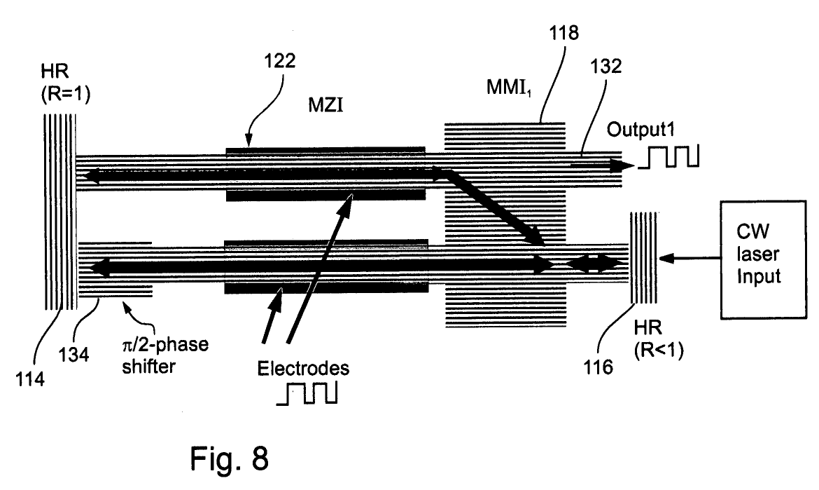

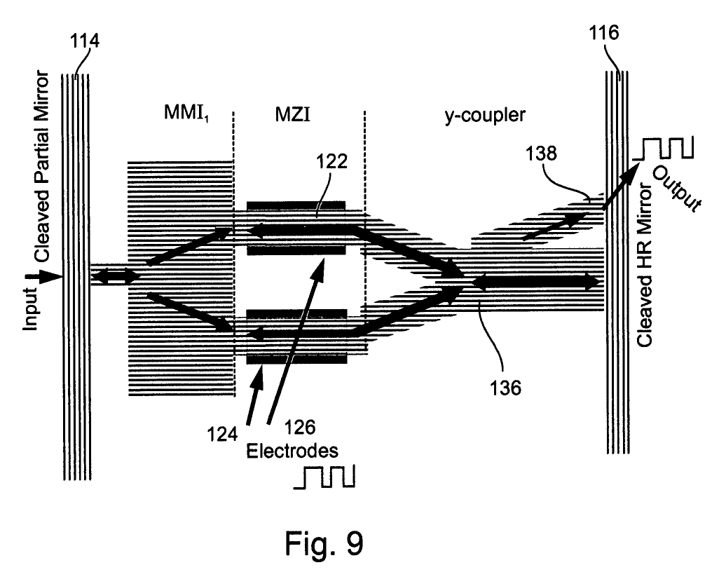

Reference is now made to FIG. 8, which is a simplified schematic diagram showing in greater detail a MZI based light modulator of the embodiment of FIG. 4 utilizing a single 2×2 MM device as the input and selective output 3 dB couplers. The device is substantially similar to the device of FIG. 7 above in respect with electrode configuration and MMI functionality, but utilizing a simple phase shifter 134 to replace MMI₂ in FIG. 7. Parts that are the same as those in previous figures are given the same reference numerals and are not described again except as necessary for an understanding of the present embodiment. Inspecting FIG. 8, it can be seen that without an external field, light in mode n (an anti-symmetric system mode) accumulates in the cavity. Upon the application of an external electric field, light is coupled to an orthogonal mode that leaves the cavity via the output waveguide. The major advantage of this configuration over the configuration presented in FIG. 7 is the need for only one MMI, which simplifies the manufacturing of the device and increase the active size of the device (I.e. the size of the MZI).

Reference is now made to FIG. 9, which is a simplified schematic diagram of a MZI based modulation device of the embodiment of FIG. 4. The device is similar to the device in FIG. 6 but the second 2×3 MMI 120 is replaced by an asymmetric Y-coupler 136 with a single output 138. The anti-symmetric mode is selectively extracted to output 138 using the Y-coupler 136 to separate between the symmetric and anti-symmetric modes. Parts that are the same as those in previous figures are given the same reference numerals and are not described again except as necessary for an understanding of the present embodiment. The device comprises a cavity defined by mirrors 114 and 116 as in the embodiment of FIG. 6. Light in a symmetric mode is coupled into the cavity and amplified as before. The MZI 122 transforms the signal into an anti-symmetric mode in accordance with an electrical signal across the electrodes 124, 126. The second MMI 120 is replaced by an asymmetric Y-coupler 136 with a single output 138. The anti-symmetric mode is selectively extracted to output 138 using the Y-coupler 136 to separate between the symmetric and anti-symmetric modes.

Again, both light amplification and modulation are carried out within the cavity, and again the device 135 may be combined with a gain medium within the cavity to form an internally modulated laser of the kind shown in FIG. 5. In such a case the input mirror 114 may be replaced by a fully reflective mirror. It will be appreciated that in the configuration shown, light comes out at an angle and waveguides may thus be angled to lead the light past the mirror preferably utilizing the Brewster angle.

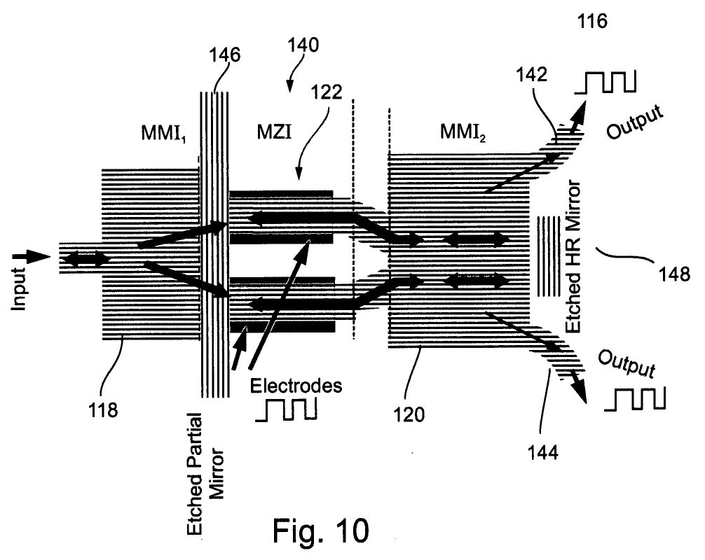

Reference is now made to FIG. 10, which is a simplified schematic diagram showing a further MZI based modulation device according to the embodiment of FIG. 4. Parts that are the same as those in previous figures are given the same reference numerals and are not described again except as necessary for an understanding of the present embodiment. In the embodiment of FIG. 10, device 140 again comprises MZI 122 sandwiched between two multi-mode interfaces 118 and 120. Two outputs 142 and 144 are provided from a 2×4 multimode interface 120, and the cavity is defined by two mirrors 146 and 148. In this example, the two mirrors are etched mirrors, a first of which 146 is placed between the first MMI 118 and the MZI 122. The first mirror 146 is a partial mirror to provide a light input for the cavity.

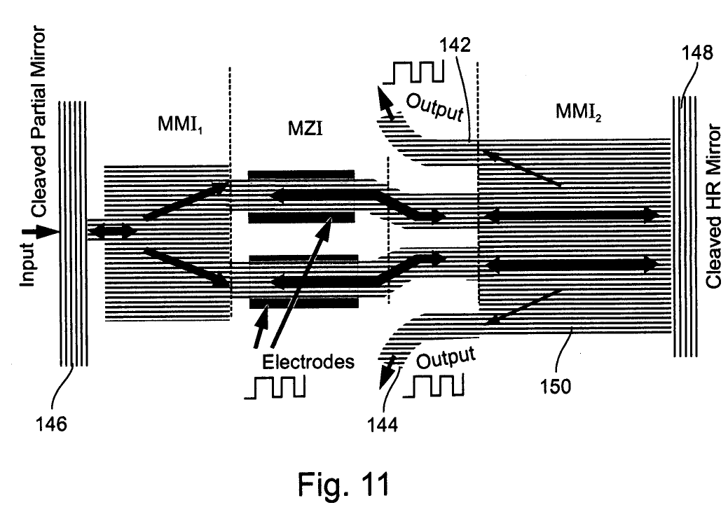

Reference is now made to FIG. 11, which is a simplified schematic diagram showing a further MZI based modulation device according to the embodiment of FIG. 4. The device is similar to the device in FIG. 6 but the second 2×3 MMI 120 is replaced by a “folded” 2×4 MMI coupler 150. Parts that are the same as those in previous figures are given the same reference numerals and are not described again except as necessary for an understanding of the present embodiment. In the embodiment of FIG. 11, device 140 again comprises MZI 122 sandwiched between two multi-mode interfaces 118 and 120. Two outputs 142 and 144 are provided from a “folded” 2×4 multimode interface 150, and the cavity is defined by two mirrors 146 and 148. The “folding” of the MMI 150 is preferably provided by use of a mirror that “folds” the MMI so that the output coincides with its input, thus utilizing the self imaging properties of the MMI to create a self image of the symmetrical mode but transfer the anti-symmetrical mode to the output.

The embodiments of FIG. 10 and FIG. 11 may be used with a gain medium within the cavity to form a directly modulated laser, in which case one-way input mirror 146 may be replaced by a fully reflective mirror.

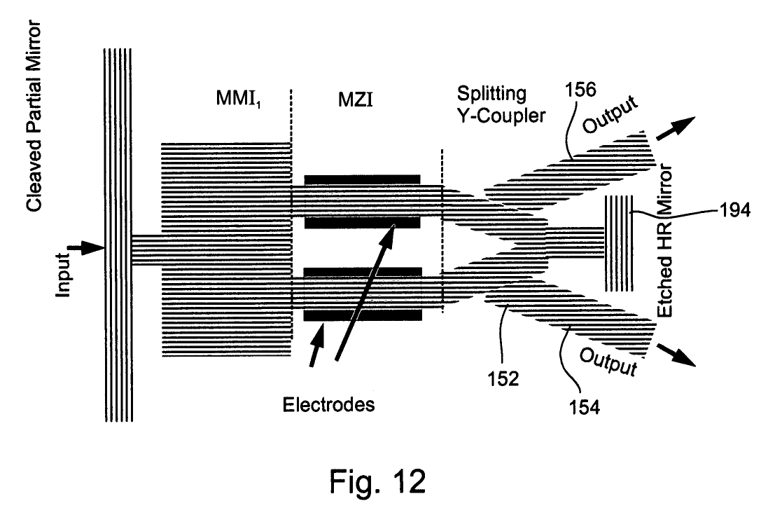

Reference is now made to FIG. 12, which is a simplified schematic diagram of a MZI-based light modulator according to a further preferred embodiment of the present invention. The device is similar to the device in FIG. 6 but the second 2×3 MMI 120 is replaced by a symmetrical Y coupler 152 with two additional waveguides 154, 156, at an angle to provide the output waveguides. Parts that are the same as those in previous figures are given the same reference numerals and are not described again except as necessary for an understanding of the present embodiment and the cleaved HR mirror 116 is replaced by an etched HR mirror 194. The splitting Y-coupler 152 is a symmetric Y-coupler with a single mode waveguide at the center. Consequently the zero order (symmetric) mode is directed into the central guide whereas the second order (anti-symmetrical) mode is transferred to the two angled waveguides 154 and 156. Thus, Y coupler 152 serves to split the symmetric and anti-symmetric modes, and direct the anti-symmetric mode to the output.

As before, an internally modulated laser may be achieved by inserting a gain medium within the cavity and dispensing with the light input by replacing one-way mirror 114 with a fully reflective mirror.

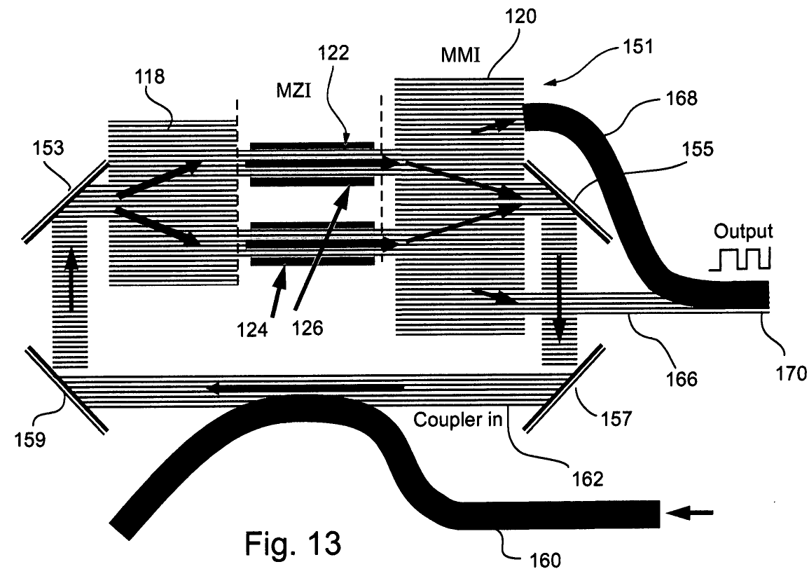

Reference is now made to FIG. 13, which is a simplified schematic diagram showing in greater detail a MZI based light modulator of the embodiment of FIG. 4 utilizing a 1×2 MMI device as the input 3 dB coupler and a 2×3 output combiner. The device is identical to the device in FIG. 6 but in place of an FP cavity it comprises a ring cavity. Parts that are the same as those in previous figures are given the same reference numerals and are not described again except as necessary for an understanding of the present embodiment. A device 151 comprises a circular cavity defined by four angled mirrors 153, 155, 157 and 159. Light input in this example is achieved by merging of an input waveguide 160 with a cavity waveguide 162. MZI 122 links two MMIs 118 and 120 as in the embodiment of FIG. 7, again within the cavity. As before, the MZI serves to selectively decouple light from the cavity to two outputs 166 and 168 which are combined downstream to form an overall output 170. Because a circular cavity is used, the direction of light travel within the cavity is preferably the same as the direction of travel of the electrical signal across the electrodes 124, 126, thereby to achieve velocity matching between the light and the signal, as discussed in Ring resonators) V. Van, Member, IEEE, Philippe P. Absil, J. V. Hryniewicz P.-T. Ho, “Propagation Loss in Single-Mode GaAs-AlGaAs Microring Resonators: Measurement and Model”, Journal of Lightwave Technology vol. 19 No. 11, pp. 1734-1739 November 2001, the contents of which are hereby incorporated by reference. The electrodes thus comprise velocity matched traveling wave electrodes.

In the embodiment of FIG. 12, the input waveguide 160 touches the cavity waveguide 162, thus transferring light thereto. The output coupling is achived using two output MMIs 120, and light from the two branches is combined after adding a 180° phase shift to one branch. Thus, substantially all the light intensity in the asymmetric mode is used in the output signal.

As with all the previous embodiments, a gain medium may be added within the cavity to form a modulated laser. In such a case the directional input coupler 160 is not required.

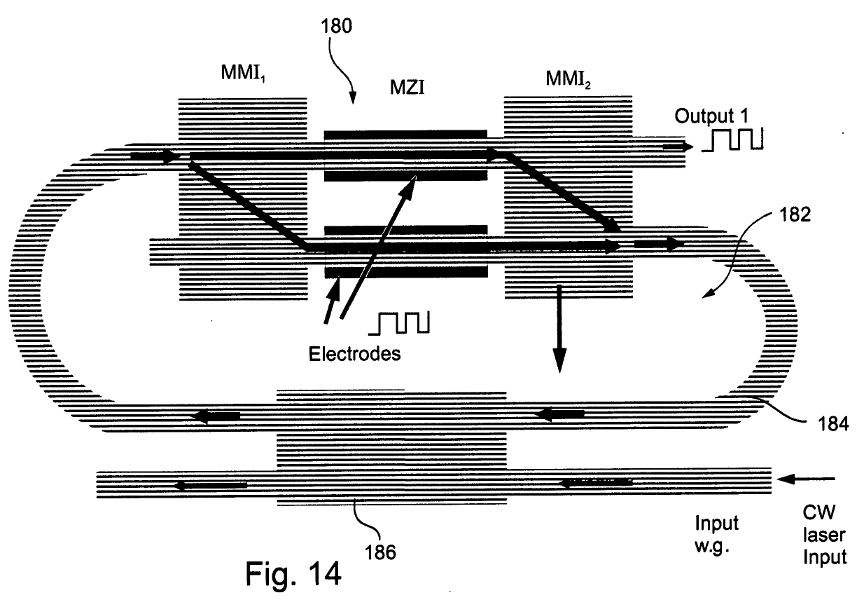

Reference is now made to FIG. 14, which is a simplified schematic diagram showing in greater detail a MZI based light modulator of the embodiment of FIG. 4 utilizing two identical 2×2 MM devices as the input coupler and output combiner. The device is identical to the device in FIG. 7 but in place of an FP cavity, it comprises a ring cavity. Parts that are the same as those in previous figures are given the same reference numerals and are not described again except as necessary for an understanding of the present embodiment. A device 180 has a ring circular-type cavity 182 defined by a curved waveguide 184. Coupling-in is achieved using a MMI coupler 186. The input MMI coupler may sometimes utilize a Butterfly configuration, and reference is herein made to Pierre A. Besse, Emilio Gini, Maurus Bachmann, Hans Melchior, “New 2×2 and 1×3 Multimode Interference Couplers with Free Selection of Power Splitting Rathios”, Journal Of Lightwave Technology, Vol. 14, No 10, pp. 2286-2293, October 1996, the contents of which are hereby incorporated by reference, so that it couples only a pre-designed ratio of the input power into the cavity. For an optimal operation of the modulator, the ratio of input power may provide optimal coupling, that is, the input power may equal the total loss in the cavity. Modulation is achieved using an MZI as before, and the second MMI preferably directs only the non-resonant (symmetric) mode to the output. Because a circular cavity is used, the direction of light travel within the cavity is preferably the same as the direction of travel of the electrical signal across the electrodes 124, 126, thereby to achieve velocity matching between the light and the signal, as discussed in reference V. Van, Member, IEEE, Philippe P. Absil, J. V. Hryniewicz P.-T. Ho, “Propagation Loss in Single-Mode GaAs-AlGaAs Microring Resonators: Measurement and Model”, Journal of Lightwave Technology vol. 19 No. 11, pp. 1734-1739 November 2001 The electrodes thus comprise velocity matched traveling wave electrodes.

As before, a directly modulated laser may be achieved by inserting a gain medium within the cavity and dispensing with the light input.

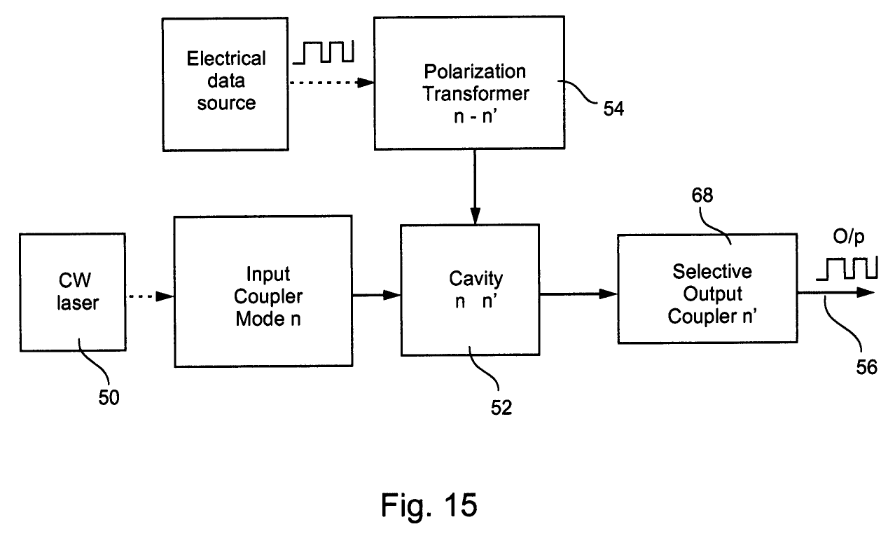

Reference is now made to FIG. 15, which is a simplified schematic diagram showing in greater detail a polarization-based light modulator of the embodiment of FIG. 3. Input light from CW laser or other source 50 is coupled into a cavity 52 with a resonantly amplified mode n. Without external interference, due to the mutual orthogonality of modes n and n′, ideally, no light enters mode n′. A Polarization transformer 54 conditionally transforms light from mode n to mode n′, an orthogonal polarization. Within the transformer the electrodes receive an electrical signal input which is applied to the light path to rotate the refractive index axis in the waveguides and consequently alter the polarization of light traveling therein, and thus, transforming light between the orthogonal modes n and n′. A selective output coupler 68 preferably acts as a polarizer that decouples the light in mode n′ so that it may reach the output 56.

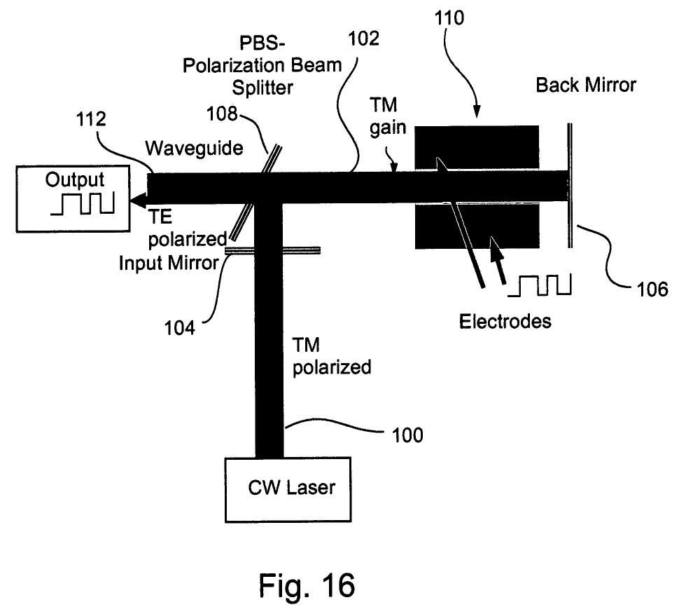

Reference is now made to FIG. 16, which is a simplified schematic diagram showing in greater detail a polarization-mode transformation based light modulator of the embodiment of FIG. 15. In the embodiment of FIG. 16, a CW laser 100 provides TM polarized light (mode n; solid line) to a cavity 102 defined by an input mirror 104, a back mirror 106 and a polarization beam splitter (PBS) 108. The input mirror 104 serves as the coupler. The PBS 108 is fully reflective to TM polarized light, which is thus trapped in the cavity 102, allowing the cavity 102 to serve as a light amplifier for the TM polarized mode (solid line), as in previous embodiments.

A modulation region 110 allows application of an external RF signal to the cavity to apply the electro-optical polarization effect. Under influence of the effect, some of the light is transformed to the TE polarization mode (mode n′; dashed) and is decoupled from the cavity, via the polarization beam splitter which is transparent to the TE polarization, to output 112. The PBS thus serves as the selective out coupler.

The arrangement of FIG. 16 may be used as is to provide a light modulator, or it may be used in conjunction with a gain medium to provide an internally modulated laser. In the case of the internally modulated laser, a light input is not required and thus the overall configuration may be simplified.

The devices of FIGS. 3-16 are characterized by small dimensions; low drive voltage; and a high modulation bit rate - from 10 Gb/s to 200 Gb/s. In addition, the output pulses of the device have a very small chirp parameter, which is preferable for long haul communication systems.

Advantageous use of cavity based modulators involves the use of optimal coupling for input to the cavity. Optimal coupling means using a coupling selected for maximum power input to the cavity. The selection depends on the situation, in particular on the wavelength that it is desired to modulate. Optimization generally involves tuning of the cavity, in that the user preferably carries out active tuning for the desired wavelength.

It will be noted that the above examples alternate between circular cavities and FP cavities. Generally, the choice between the two depends upon the speed of the modulation required. If the time per bit is longer than the time required for a photon to pass an electrode then it makes sense to use an FP cavity. The mirrors ensure that the light passes in two directions over the electrodes, thereby doubling the modulation effect. If on the other hand the time per bit is shorter than the time taken by a photon to pass an electrode then there is a problem of smearing of the signal. In such a case it is preferable to use a circular cavity which allows velocity matching between the electrical signal and the light, as described above, thereby to eliminate smearing.

Preferred materials for the light modulator of the above embodiments are the gallium arsenide and indium phosphide families of optical materials. Alternative materials include lithium Niobate and electro-optic photopolymers.

There is thus provided a light modulation device that allows for multi-gigabyte range optical modulation with low, zero or negative chirp and high extinction rate. There is also provided a internally modulated laser. The devices are based on a two-mode (or sometimes more) system in a cavity, where one of the modes is in resonance. An applied voltage couples the light from the mode in resonance to the second mode. A mode selector selects the second or assymetric mode, and directs it to the output port, and out of the cavity, whilst the first or symmetric mode remains within the cavity. The assymetric mode has a lower inertia and therefore greater switching speed is achieved, whilst at the same time the symmetric mode allows significant light amplification within the cavity, so that only a low voltage is required to achieve a given light output. In consequence, devices can be achieved which have drive voltages as low as 2V with low chirp and high extinction ratio, and which can function at bit rates as high as 40 Gbit/sec.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. An optical modulator for modulating light with an electrical signal, the modulator comprising:
an optical cavity, for enhancing an optical field of said light in a first mode,
an electrical input for receiving an electrical signal,
a transformer associated with said cavity and with said electrical input for transforming light within said first optical mode into a second mode substantially orthogonal to said first mode, in accordance with said electrical signal, and
a selective output coupler associated with said optical cavity, to couple said second mode to an output, thereby to provide, at said output, light modulated in accordance with said electrical signal.

2. The optical modulator of claim 1, wherein said cavity is a Fabry-Perot cavity, comprising at least two bounding mirrors.

3. The optical modulator of claim 2, wherein at least one of said bounding mirrors is a DBR mirror.

4. The optical modulator of claim 2, wherein at least one of said bounding mirrors is a cleaved mirror.

5. The optical modulator of claim 2, wherein at least one of said bounding mirrors is an etched mirror.

6. The optical modulator of claim 2, wherein at least one of said bounding mirrors is obtained by polishing.

7. The optical modulator of claim 2, wherein said bounding mirror has an HR coating.

8. The optical modulator of claim 1, wherein said cavity is a ring cavity.

9. The optical modulator of claim 8, wherein said ring cavity is a circular cavity.

10. The optical modulator of claim 8, wherein said ring cavity is substantially polygonal.

11. The optical modulator of claim 8, wherein said ring cavity is substantially triangular.

12. The optical modulator of claim 8, wherein said ring cavity is substantially quadrilateral.

13. The optical modulator of claim 8, wherein said ring cavity is substantially oblong.

14. The optical modulator of claim 1, wherein said cavity is substantially utilized with a photonic-band-gap material.

15. The optical modulator of claim 1, wherein said cavity is arranged to have an optical signal traveling in substantially two directions, each direction constituting one of said modes.

16. The optical modulator of claim 1, further comprising an input coupler for receiving the input light substantially into said first mode.

17. The optical modulator of claim 17 wherein said input coupler is any one of a group comprising a directional coupler; an asymmetric directional coupler; an MMI; a Bragg grating; a Y coupler; an Asymmetric Y coupler; an HR coating and a free space diffractor.

18. The optical modulator of claim 1, wherein said transformer is an interference based transformer.

19. The optical modulator of claim 18, wherein said transformer is a MZI based transformer.

20. The optical modulator of claim 1 wherein said transformer comprises an electrode set, associated with said electrical input, for effecting a phase related property of the light via an electro-optical effect to transform photons from said first optical mode to said second mode, in accordance with said electrical signal, said electrical signal being arranged for application across said electrode set.

21. The optical modulator of claim 20, wherein a first electrode of said electrode set is supplied with said electrical signal, a second electrode being held at a constant voltage.

22. The optical modulator of claim 20, wherein said electrode are set in a push-pull schema.

23. The optical modulator of claim 1, wherein said modulator is arranged to have the optical signal traveling in a substantially single direction, said direction being matched to a propagation direction of said electrical signal.

24. The optical modulator of claim 23, wherein said electrical signal is arranged to have the same velocity of propagation as the velocity of said optical signal within said transformer.

25. The optical modulator of claim 19, wherein said orthogonal modes are symmetric and anti-symmetric modes of said MZI.

26. The optical modulator of claim 19, wherein said MZI utilizes two 2×2 MMI at the input and output ports.

27. The optical modulator of claim 19, wherein said MZI utilizes a 1×2 MMI at the input and a 2×3 MMI at the output ports, respectively.

28. The optical modulator of claim 19, wherein said MZI utilizes a single 1×2 MMI at the input and output at the same time combined with a π/2 phase shifter.

29. The optical modulator of claim 26, wherein said cavity is a FP cavity.

30. The optical modulator of claim 27, wherein said cavity is an FP cavity.

31. The optical modulator of claim 28, wherein said cavity is an FP cavity.

32. The optical modulator of claim 26, wherein said cavity is a ring cavity.

33. The optical modulator of claim 27, wherein said cavity is a ring cavity.

34. The optical modulator of claim 1, wherein said selective output coupler is any one of a group comprising a directional coupler; an asymmetric directional coupler; an MMI; a Bragg grating; an Asymmetric Y coupler; a symmetric Y coupler with a single-mode central waveguide combined with a pair of angled waveguides as the output waveguides; and a free space diffraction.

35. The optical modulator of claim 1, wherein said modulator is a polarization-based modulator and said substantially orthogonal modes are substantially orthogonal polarizations.

36. The optical modulator of claim 35, wherein said optical cavity is a FP cavity.

37. The optical modulator of claim 35, wherein said optical cavity is a ring cavity.

38. The optical modulator of claim 35, wherein said selective output coupler is a polarization beam splitter.

39. The optical modulator of claim 35, wherein said selective output coupler is a waveguide based polarization beam splitter.

40. The optical modulator of claim 35, wherein said selective output coupler is an interference based polarization splitter.

41. The optical modulator of claim 35, wherein said substantially orthogonal polarizations are a substantially TM and substantially TE modes of a waveguide.

42. The optical modulator of claim 41, wherein said transformer is operable to transform light within said cavity between said substantially TM mode and said substantially TE mode and wherein said polarization beam splitter is reflective to light in said substantially TM mode and transparent to light in said substantially TE mode.

43. The optical modulator of claim 41, wherein said transformer is operable to transform light within said cavity between said substantially TM mode and said substantially TE mode and wherein said polarization beam splitter is reflective to light in said substantially TE mode and transparent to light in said substantially TM mode.

44. The optical modulator of claim 35, wherein said transformer comprises an electrode set, associated with said electrical input, for effecting a polarization related property via an electro-optical effect to transform photons from said first optical mode to said second mode, in accordance with said electrical signal, said electrical signal being arranged for application across said electrode set.

45. The optical modulator of claim 44, wherein said electro-optic effect is the electro-optically induced polarization coupling effect.

46. The optical modulator of claim 44, wherein a first electrode of said electrode set is supplied with said electrical signal, a second electrode being held at a constant voltage.

47. The optical modulator of claim 44, wherein said electrode set is arranged in a Push-Pull schema.

48. The optical modulator of claim 44, wherein said electrode set is arranged in a segmented schema in order to obtain a phase matching between said orthogonal polarizations.

49. The optical modulator of claim 35, further comprising an optical gain medium within said optical cavity.

50. The optical modulator of claim 35, further operable as a laser.

51. The optical modulator of claim 19, further comprising an optical gain medium within said optical cavity.

52. The optical modulator of claim 19, further operable as a laser.

53. The optical modulator of claim 1, wherein, for a null electrical signal at said electrical input, substantially no light is coupled from said optical cavity to said output.

54. The optical modulator of claim 1, wherein said electrical signal is within the radio frequency range.

55. The optical modulator of claim 1, wherein said orthogonal modes are waveguide modes.

56. The optical modulator of claim 55, wherein said waveguide are single mode waveguides.

57. The optical modulator of claim 55, wherein said waveguide is a multimode waveguide.

58. The optical modulator of claim 1, substantially constructed using semiconductor optical materials.

59. The optical modulator of claim 58, substantially constructed using a combination from the III-V semiconductor compounds.

60. The optical modulator of claim 58, substantially constructed using a combination from the IV-VI semiconductor compounds.

61. The optical modulator of claim 59, substantially constructed using a combination from the GaAs/AlGaAs family of optical materials.

62. The optical modulator of claim 59, substantially constructed using a combination from the InP/InGaAsP family of optical materials.

63. The optical modulator of claim 1, substantially constructed using Lithium-Niobate (LiNbO₃).

64. The optical modulator of claim 1, substantially constructed using electro-optic photopolymers.

65. The optical modulator of claim 1, substantially constructed using reverse-biased PIN or Schottky-I/N diode in order to enhance the Electrooptic effect.

66. The optical modulator of claim 1, substantially constructed using Quantum-Wells in order to enhance the Electrooptic effect.

67. The optical modulator of claim 1, substantially constructed using resonant-tunneling diode (RTD) in order to enhance the Electrooptic effect.

68. The optical modulator of claim 1, further utilizing a built-in transistor in order to enhance the Electrooptic effect.

69. The optical modulator of claim 1, further utilizing a built-in field effect transistor (FET) in order to enhance the Electrooptic effect.

70. An internally modulated laser comprising
an optical cavity for enhancing light in a substantially first mode and providing laser feedback,
an optical gain medium associated with said cavity,
an electrical input for receiving an electrical signal,
a transformer, associated with said electrical input and with said cavity, to couple light in said optical cavity from said first mode to a second mode, in accordance with said electrical signal, and
a selective output coupler, to direct said light in said second mode to an output.

71. The laser of claim 70, wherein said cavity is a Fabry-Perot cavity, comprising at least two bounding mirrors.

72. The laser of claim 71, wherein at least one of said bounding mirrors is a DBR mirror.

73. The laser of claim 71, wherein at least one of said bounding mirrors is a cleaved mirror.

74. The laser of claim 71, wherein at least one of said bounding mirrors is an etched mirror.

75. The laser of claim 71, wherein at least one of said bounding mirrors is obtained by polishing.

76. The laser of claim 71, wherein said bounding mirror has an HR coating.

77. The laser of claim 70, wherein said cavity is a ring cavity.

78. The laser of claim 77, wherein said ring cavity is a circular cavity.

79. The laser of claim 77, wherein said ring cavity is substantially polygonal.

80. The laser of claim 77, wherein said ring cavity is substantially triangular.

81. The laser of claim 77, wherein said ring cavity is substantially quadrilateral.

82. The laser of claim 77, wherein said ring cavity is substantially oblong.

83. The laser of claim 70, wherein said cavity is substantially utilized with a photonic-band-gap material.

84. The laser of claim 70, wherein said cavity is arranged to have an optical signal traveling in substantially two directions, each direction constituting one of said modes.

85. The laser of claim 70, wherein said modes are orthogonal modes.

86. The laser of claim 70, wherein said transformer is an interference based transformer.

87. The laser of claim 86, wherein said transformer is a MZI based transformer.

88. The laser of claim 70, wherein said transformer comprises an electrode set, associated with said electrical input, for effecting a phase related property of the light via an electro-optical effect to transform photons from said first optical mode to said second mode, in accordance with said electrical signal, said electrical signal being arranged for application across said electrode set.

89. The laser of claim 88, wherein a first electrode of said electrode set is supplied with said electrical signal, a second electrode being held at a constant voltage.

90. The laser of claim 88, wherein said electrode are set is the push-pull schema.

91. The laser of claim 70, wherein said laser is arranged to have the optical signal traveling in a substantially single direction, said direction being matched to a propagation direction of said electrical signal.

92. The laser of claim 70, wherein said electrical signal is arranged to have a same velocity of propagation as a velocity of said optical signal within said transformer.

93. The laser of claim 87, wherein said orthogonal modes are symmetric and anti-symmetric modes of said MZI.

94. The laser of claim 87, wherein said MZI utilizes two 2×2 MMI.

95. The laser of claim 87, wherein said MZI utilizes a 1×2 MMI and a 2×3 MMI.

96. The laser of claim 87, wherein said MZI utilizes a single 1×2 MMI combined with a π/2 phase shifter.

97. The laser of claim 94, wherein said cavity is a FP cavity.

98. The laser of claim 95, wherein said cavity is a FP cavity.

99. The laser of claim 96, wherein said cavity is a FP cavity.

100. The laser of claim 94, wherein said cavity is a ring cavity.

101. The laser of claim 95, wherein said cavity is a ring cavity.

102. The laser of claim 70, wherein said selective output coupler is any one of a group comprising a directional coupler; an asymmetric directional coupler; an MMI; a Bragg grating; an Asymmetric Y coupler; a symmetric Y coupler with a single-mode central waveguide combined with a pair of angled waveguides as the output waveguides; and a free space diffraction.

103. The laser of claim 70, wherein said gain medium is located at an active section within said cavity.

104. The laser of claim 70, wherein said cavity further comprises at least one section for tuning the laser wavelength thereby to provide a tunable internally modulated laser.

105. The laser of claim 70, wherein, for a null electrical signal at said electrical input, substantially no light is coupled from said optical cavity to said output.

106. The laser of claim 70, wherein said electrical signal is within the radio frequency range.

107. The laser of claim 85, wherein said orthogonal modes are waveguide modes.

108. The laser of claim 70, substantially constructed using semiconductor optical materials.

109. The laser of claim 70, substantially constructed using LiNbO₃ as the electro-optical material.

110. The laser of claim 70, substantially constructed using a reverse-biased PIN or Schottky-I/N diode in order to enhance the Electrooptic effect.

111. The laser of claim 70, substantially constructed using electrooptic photopolymers.

112. The laser of claim 70, substantially constructed using Quantum-Wells in order to enhance the Electrooptic effect.

113. The laser of claim 70, further utilizing using a built-in transistor in order to enhance the Electrooptic effect.

114. The laser of claim 70, further utilizing a built-in field effect transistor (FET) in order to enhance the Electrooptic effect.

115. The laser of claim 70, wherein said transformer is a polarization-based transformer and said orthogonal modes are substantially orthogonal polarizations of a waveguide.

116. The laser of claim 115, wherein said selective output coupler is a polarization beam splitter.

117. The laser of claim 103, wherein said passive section is obtained by a method of Quantum-Well intermixing.

118. The laser of claim 103, wherein said passive section is obtained by a method of over growth.

119. The laser of claim 70, wherein a single mode operation is obtained utilizing a DBR section.

120. The laser of claim 70, wherein a single mode operation is obtained utilizing an external cavity.

121. The laser of claim 70, wherein a single mode operation is obtained utilizing DFB.

122. A method of modulating light according to an electrical signal, comprising:
setting up an optical cavity for light in a predetermined optical state, there being a second state orthogonal to said first state,
pumping said light into an optical cavity tuned for said first state,
applying said electrical signal about said optical cavity to transform at least some of the light thereabout, via the electro-optical effect, to enter said second state, and
coupling at least some of said transformed light from said cavity, to an optical signal output, thereby to provide at said optical signal output, light modulated with said electrical signal, and wherein said second state is substantially orthogonal to said first state.
